(19) United States
(12) Patent Application Publication
(10) Pub. No.: US 2024/0343092 A1
(43) Pub. Date: Oct. 17, 2024

(54) VENTILATION UNIT AND RECREATIONAL VEHICLE WITH A VENTILATION UNIT

(71) Applicant: Dometic Sweden AB, Solna (SE)

(72) Inventors: Sergej Krist, Neunkirchen (DE); Tobias Hommerich, Siegen (DE); Torsten Glieden, Siegen (DE); Marcus Dietrich, Netphen (DE)

(21) Appl. No.: 18/293,054

(22) PCT Filed: Jun. 23, 2022
(86) PCT No.: PCT/EP2022/067107

§ 371 Date: Jan. 29, 2024

(30) Foreign Application Priority Data
Jul. 30, 2021 (DE) 102021208289.0

(51) Int. Cl. B60H 1/26; B60H 1/00

(52) U.S. Cl. CPC B60H 1/262; B60H 1/00364

(57) ABSTRACT

The present embodiments refer to a ventilation unit, in particular for recreational vehicles like campers, caravans or mobile homes. The ventilation unit comprises an air intake arrangement configured to define an intake air flow path from the environment of a confined space into the confined space in an installed state of the ventilation unit. The ventilation unit further comprises an air exhaust arrangement configured to define an exhaust air flow path from the confined space to the environment of the confined space in an installed state of the ventilation unit. According to the present embodiments, the ventilation unit comprises a heat transfer unit configured to conduct a passive heat transfer between intake air within the intake air flow path and exhaust air within the exhaust air flow path. Furthermore, the present embodiments refer to a recreational vehicle like a camper, caravan or mobile home comprising such a ventilation unit.

### CLAIM TO PRIORITY

This 35 U.S.C. § 371 National Stage Patent Application claims priority to and benefit of PCT Patent Application No. PCT/EP2022/067107, filed Jun. 23, 2022, all of which is incorporated by reference herein.

### BACKGROUND

This disclosure relates to a ventilation unit and more particularly but without limitation, a recreational vehicle with such a ventilation unit.

In general, confined spaces in which persons are expected to spend their time, have to be provided with ventilation units to ensure an appropriate supply with fresh air for the persons within the confined space. This holds in particular for relatively limited confined spaces as it is the case for example in recreational vehicles like campers, caravans or mobile homes. It has been observed that during ventilation processes with common ventilation units, undesired temperature variations within the confined space can occur due to a temperature difference between the intake air from the environment and the exhaust air from the confined space.

In view of this problem, it is the scope of the present embodiments to provide a ventilation unit allowing ventilation processes with considerably decreased temperature variations within the confined space during ventilation processes.

This scope is achieved by the ventilation unit according to claim 1 wherein optional modifications thereof are presented in the dependent claims.

### SUMMARY

According to a first aspect, a ventilation unit, in particular for recreational vehicles like campers, caravans or mobile homes, comprises an air intake arrangement and an air exhaust arrangement. The air intake arrangement is configured to define an intake air flow path from the environment into a confined space in an installed state of the ventilation unit. The air exhaust arrangement is configured to define an exhaust air flow path from the confined space to the environment in an installed state of the ventilation unit. The ventilation unit further comprises a heat transfer unit configured to conduct a passive heat transfer between intake air within the intake air flow path and exhaust air within the exhaust air flow path.

Via the passive heat transfer, the intake air from the environment of the confined space is cooled or heated passively via the exhaust air within the exhaust air flow path such that the temperature of the intake air flow is changed towards the temperature of the exhaust air reducing temperature variations resulting from the ventilation process. According to some embodiments, this is achieved without the need of complex and in many times expensive air conditioning arrangements like cooling circuits or similar.

Instead, the air intake arrangement may comprise an intake fan unit configured to force a flow of intake air through the intake air flow path. In addition or alternatively, the air exhaust arrangement comprises an exhaust fan unit configured to force a flow of exhaust air through the exhaust air flow path. This configuration allows to increase the amount of air replaced within the confined space by the ventilation unit.

The heat transfer unit may comprise a heat transfer disc and a rotation motor configured to rotate the heat transfer disc. The heat transfer disc is configured such that always one section of the heat transfer disc is in contact with intake air within the intake air flow path and another section of the heat transfer disc is in contact with exhaust air within the exhaust air flow path. With the rotation motor, the section of the heat transfer disc being in contact with the intake air can be moved into contact with the exhaust air and the section of the heat transfer disc being in contact with the exhaust air can be moved into contact with the intake air resulting in a very efficient heat transfer between the exhaust air and the intake air. Thus, a quite simple but reliable implementation for the heat transfer unit is activated.

The intake fan unit and/or the exhaust fan unit may comprise a fan driven by an electric motor with control input. In particular, the electric motor is a 12 Volt DC motor operated by pulse width modulated operation signals. In addition or alternatively, the rotation motor is a 12 Volt DC motor operated by pulse width modulated operation signals. Such motors allow the implementation of highly controllable, reliable and quite inexpensive overall configurations.

The ventilation unit may comprise a control unit. The control unit has a printed circuit board. The control unit is configured to control the operation of the intake fan unit, of the exhaust fan unit and/or of the heat transfer unit. In particular, the control unit is configured to control the electric motors of the fan units and/or the rotation motor of the heat transfer unit. Such a control unit allows a central and highly specific control of the operation of the various components of the ventilation unit

The control unit is configured to receive and to process signals from a gas sensor, in particular from a carbon dioxide sensor (CO2 sensor) and/or a volatile organic compounds sensor, measuring the air quality within the confined space. Furthermore, the control unit is configured to control the components of the ventilation unit based on these signals. Such a configuration allows an automated control of the various components of the ventilation unit.

The control unit may be configured to receive and to process signals from a differential pressure sensor. The control unit is further configured to control the components of the ventilation unit to provide a predetermined over-pressurization within the confined space with respect to the environment. Thus, it is possible to set and to keep a predetermined over-pressure within the confined space as compared to the environment as it is desired in general.

The ventilation unit may comprise a housing surrounding various components of the ventilation unit. The housing is coupled to a base of the ventilation unit, while the base is configured to attach the ventilation unit to a desired location. In particular, the housing is made of fiber reinforced material, for example of hemp fiber reinforced polypropylene. Such a housing ensures the protection of the various components of the ventilation unit while being lightweight at the same time, thus adding only little weight to the overall configuration.

The ventilation unit may comprise sealing members and/or filtering units. The sealing members are configured to seal various components of the ventilation unit against fluid ingress. The filtering units are configured to filter in particular intake air within the intake air flow path. Such a configuration allows to protect the ventilation unit itself as well as the confined space against pollution from the environment of the confined space.

According to another aspect of the instant embodiments, a recreational vehicle, in particular a camper, caravan or mobile home, comprises at least one of the above described ventilation units.

Thus, it is possible to take advantage of the above described technical effects achieved with the ventilation units in a recreational vehicle.

### BRIEF DESCRIPTION OF THE DRAWINGS

These and other features of the instant embodiments will become more apparent from the following detailed description of a preferred, non-limiting exemplary embodiment of the present invention, with reference to the accompanying drawings, in which:

FIG. 1 is a spatial view of ventilation unit according to one exemplary embodiment of the present invention in an installed state of the ventilation unit:

FIG. 2 is a further spatial view of the ventilation unit of FIG. 1;

FIG. 3 is a cross-sectional view of the ventilation unit of FIGS. 1 and 2;

FIG. 4 is a spatial partial view the ventilation unit of FIGS. 1 to 3;

FIG. 5 is a further spatial partial view of the ventilation unit of FIGS. 1 to 3.

### DETAILED DESCRIPTION

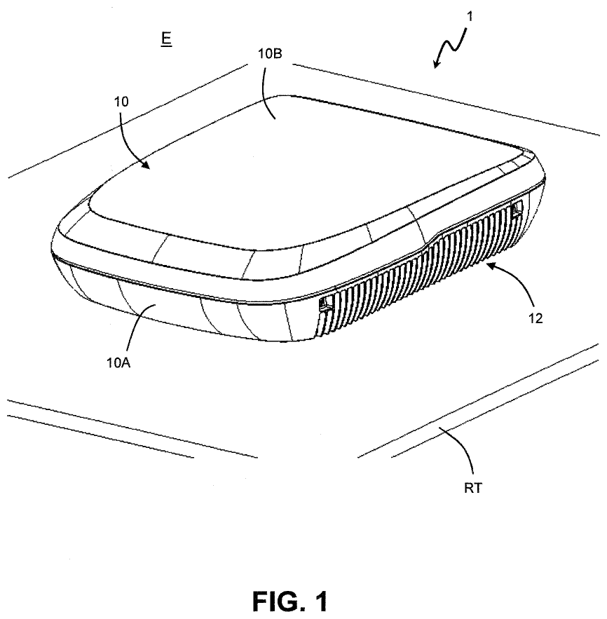

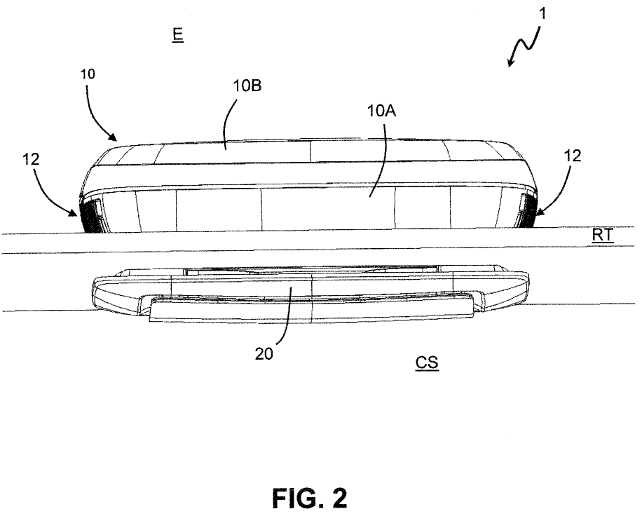

With reference to the accompanying drawings, a ventilation unit 1 comprises a housing 10. The housing 10 is coupled to a base 20 (see FIG. 2). The base 20 is configured to be coupled to a desired location of the rooftop RT of a recreational vehicle, as illustrated in FIG. 1.

The housing 10 comprises a housing frame or base 10A and a housing cover or shroud 10B. The housing frame 10A comprises ventilation openings 12 provided on two opposing sides of the ventilation unit 1, as it is for example shown in FIG. 2.

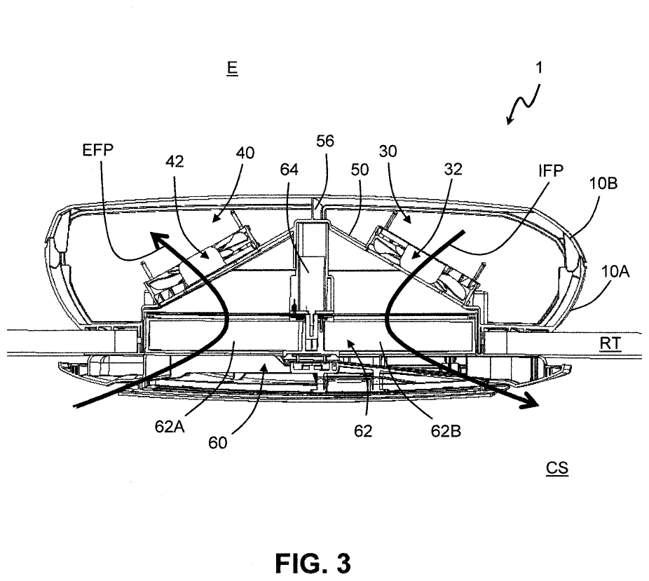

As it is best seen in FIG. 3, the ventilation unit 1 comprises an air intake arrangement 30 as well as an air exhaust arrangement 40. The air intake arrangement 30 defines an intake air flow path IFP. The air exhaust arrangement 40 defines an exhaust air flow path EFP. In a state in which the ventilation unit 1 is installed in a roof top RT, as it is illustrated in FIG. 2, the intake air flow path IFP is provided from the environment E external to a confined space CS (for example, the inside of a recreational vehicle) into the confined space CS, and the exhaust air flow path EFP is provided from the confined space CS below the rooftop RT to the environment E of to the confined space CS.

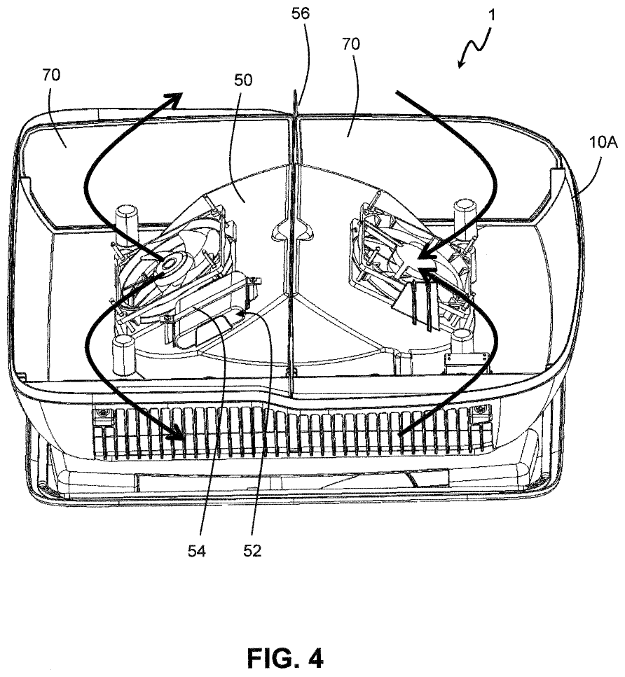

In the illustrated embodiment, the air intake arrangement 30 comprises an intake fan unit 32. The intake fan unit 32 is configured to force a flow of intake air through the intake air flow path IFP. The air exhaust arrangement 40 comprises an exhaust fan unit 42. The exhaust fan 42 is configured to force a flow of exhaust air through the exhaust air flow path EFP. As can be seen in FIGS. 3 and 4, the two fan units 32 and 42 are positioned within the housing 10 and are both provided on an internal housing 50. The internal housing 50 defines a temperature exchange room within the ventilation unit 1. A power storage 52 in the form of a battery unit is coupled to the internal housing 50 as can be seen in FIG. 4. In the present case the power storage 52 is coupled to the internal housing with a clam 54, but any other suitable means are also possible.

A separation wall 56 separates the intake air flow path IFP and the exhaust air flow path EFP within the internal housing 50 from each other. The ventilation unit 1 further has a passive heat transfer unit 60 comprising a flat heat transfer disc 62 as well as a rotation motor 64. In the illustrated embodiment, the heat transfer disc 62 is a perforated ceramic disc. However, also other configurations are possible. The rotation motor 64 is positioned within a space which is built in the separation wall 56 and is coupled to the heat transfer disc 62 in such a manner that the rotation motor 64 is configured to rotate the heat transfer disc 62.

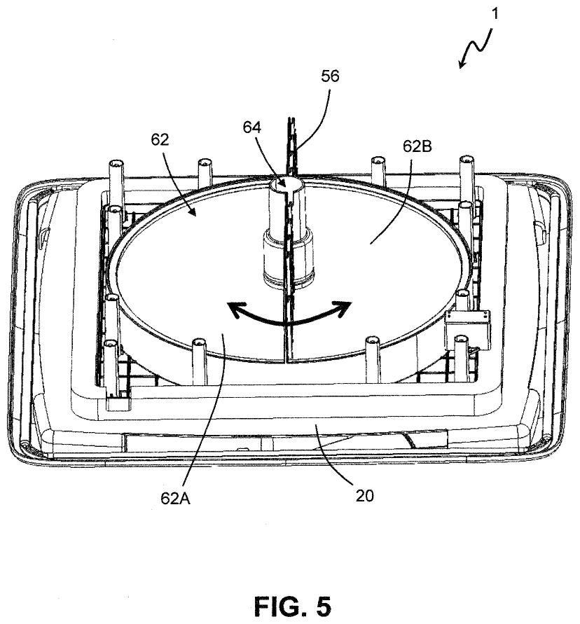

As it is illustrated in FIG. 5, the heat transfer disc 62 is configured such that a first section 62A of the heat transfer disc 62 is in contact with the exhaust air flow path side of the temperature exchange room within the internal housing 50 (on the left). A second section 62B of the heat transfer disc 62 is in contact with the intake air flow path side of the temperature exchange room within the internal housing 50 (on the right). Thus, the first section 62A is in contact with exhaust air flowing through the exhaust air flow path EFP and the second section 62B is in contact with intake air flowing through the intake air flow path IFP. During ventilation processes, the exhaust air flowing through the exhaust air flow path EFP heats or cools the first section 62A of the heat transfer disc 62 depending on the temperature of the exhaust air compared to the temperature of the first section 62A of the temperature transfer disc 62. Then the rotation motor 64 rotates the heated or cooled first section 62A of the heat transfer disc 62 from the exhaust air flow path EFP into the intake air flow path IFP. Thus, the respective section of the heat transfer disc 62 which is rotated into the intake air flow path IFP becomes the second section 62B of the heat transfer disc 62. Then the heated or cooled second section 62B of the heat transfer disc 62 heats or cools the intake air flowing through the intake air flow path IFP. This process occurs in a continuous manner such that heat is transferred permanently between the exhaust air within the exhaust air flow path EFP and the intake air within the intake air flow path IFP.

Each of the intake fan unit 32 and exhaust fan unit 42 comprises a fan. The fan of each fan unit 32, 42 is driven by an electric motor. In the illustrated embodiment, each of the electric motors of the fan units 32 and 42 as well as the rotation motor 64 of the heat transfer unit 60 are 12 Volt DC motors operated by pulse width modulated operation signals. The electric motors of the fan units 32 and 42 and the rotation motor 64 of the heat transfer unit 60 are coupled to the power storage 52 for power supply. The ventilation unit 1 further comprises a control unit (not illustrated explicitly) having a printed circuit board. The control unit is coupled to each of the two fan units 32 and 42 as well as to the transfer unit 60 and is configured to control the operation of these components of the ventilation unit 1. In particular, the control unit is configured to provide pulse width modulated operation signals to the electric motors of the two fan units 32 and 42 as well as to the rotation motor 64 of the heat transfer unit 60.

The control unit is further configured to be coupled to gas sensors, like a CO2 sensor and a volatile organic compounds sensor measuring the air quality within the confined space CS, as well as to differential pressure sensors measuring pressure difference between environment E of the confined space CS and the confined space CS itself. Based on the signals receives from the sensors processed in the control unit, the control unit controls the various components of the ventilation unit 1 like the electric motors of the fan unit 32 and 42 or the rotation motor 64 of the heat transfer unit 60. For example, the control unit can be configured to increase the rotation speed for the fans of the fan units 32 and 42 when the air quality within the confined space CS determined by the gas sensors, falls below a predetermined value. At the same time, the control unit can set the respective rotation speeds for the fans of the fan units 32 and 42 in such a manner relative to each other that the temperature difference between the environment E of the confined space CS and the confined space CS itself is kept at a predetermined value. In particular, the confined space CS is kept at a predetermined over-pressure with respect to the environment E. Of course, the control unit can be configured such that also other sensors, like for example temperature sensors, humidity sensors, movement sensors or the like, can be coupled to the control unit to supplement and improve the functionality of the control unit.

As can be seen for example in FIG. 4, the ventilation unit 1 comprises various filtering units having filter pads 70 positioned, when seen from outside the ventilation unit 1, behind the ventilation openings 12 such that air passing through the ventilation unit 1 is filtered. Besides, the ventilation unit 1 comprises several sealing members configured to seal the various components of the ventilation unit 1 against fluid ingress.

Finally, it is highlighted that the present embodiments not only refer to the illustrated and described ventilation unit 1, but the present invention refers also to recreational vehicles like campers, caravans or mobile being provided with at least one such ventilation unit 1.

The above described configurations provide merely exemplary embodiments. Hence, the described configurations do not limit the achieved scope of protection as defined by the appended set of claims. A skilled artisan will be able to imagine various modifications of the above described configurations without contravening the basic concept of the present disclosure and/or leaving the scope of protection as defined by the appended set of claims.

### REFERENCE SIGNS

1 heating apparatus
10 housing
10A frame
10B cover
12 ventilation openings
20 base
30 air intake arrangement
32 intake fan unit
40 air exhaust arrangement
42 exhaust fan unit
50 internal housing
52 power supply
54 clamp
56 separation wall
60 heat transfer unit
62 heat transfer disc
62A first section of heat transfer disc
62B second section of heat transfer disc
64 rotation motor
70 filter pads
CS confined space
E environment
EFP exhaust air flow path
IFP intake air flow path
RT roof top

1. A ventilation unit for recreational vehicles, comprising:
an air intake arrangement configured to define an intake air flow path from the environment into a confined space in an installed state of the ventilation unit;
an air exhaust arrangement configured to define an exhaust air flow path from the confined space (CS) to the environment (E) in an installed state of the ventilation unit;
wherein the ventilation unit comprises a heat transfer unit configured to conduct a passive heat transfer between intake air within the intake air flow path and exhaust air within the exhaust air flow path.

2. The ventilation unit of claim 1, wherein
the air intake arrangement comprises an intake fan unit configured to force a flow of intake air through the intake air flow path; and/or
the air exhaust arrangement comprises an exhaust fan unit configured to force a flow of exhaust air through the exhaust air flow path.

3. The ventilation unit of claim 2, wherein
the heat transfer unit comprises a heat transfer disc and a rotation motor, the rotation motor being configured to rotate the heat transfer disc,
wherein the heat transfer disc is configured such that always one section of the heat transfer disc is in contact with intake air within the intake air flow path and another section of the heat transfer disc is in contact with exhaust air within the exhaust air flow path.

4. The ventilation unit of claim 3, wherein
the intake fan unit and/or the exhaust fan unit comprise a fan driven by an electric motor with control input, in particular a 12 Volt DC motor operated by pulse width modulated operation signals; and/or wherein
the rotation motor is a 12 Volt DC motor operated by pulse width modulated operation signals.

5. The ventilation unit of claim 4. wherein
the ventilation unit comprises a control unit having a printed circuit board,
wherein the control unit is configured to control the operation of the intake fan unit, of the exhaust fan unit and/or of the heat transfer unit.

6. The ventilation unit of claim 5, wherein
the control unit is configured to receive and to process signals from a gas sensor, in particular from a CO2 sensor and/or a volatile organic compounds sensor, measuring the air quality within the confined space, and
wherein the control unit is further configured to control the components of the ventilation unit based on the signals received from the sensors.

7. The ventilation unit of claim 6, wherein
the control unit is configured to receive and to process signals from a differential pressure sensor, and
wherein the control unit is further configured to control the components of the ventilation unit to provide a predetermined over-pressurization within the confined space with respect to the environment of the confined space.

8. The ventilation unit of claim 1, wherein
the ventilation unit comprises a housing surrounding the components of the ventilation unit and the housing being coupled to a base of the ventilation unit,
wherein the base is configured to attach the ventilation unit to a desired location, and
wherein the housing in particular is made of fiber reinforced material, preferably of hemp fiber reinforced polypropylene.

9. The ventilation unit of claim 1, wherein
the ventilation unit comprises sealing members and/or filtering units,
wherein the sealing members are configured to seal various components of the ventilation unit against fluid ingress, and
wherein the filtering units are configured to filter in particular intake air within the intake air flow path.

10. (canceled)
